(19) United States
(12) Patent Application Publication
(10) Pub. No.: US 2017/0193164 A1
(43) Pub. Date: Jul. 6, 2017

(54) SYSTEM FOR THE DISTRIBUTED COLLECTION OF BRAIN HEALTH INFORMATION

(71) Applicant: CERORA, INC.., Bethlehem, PA (US)

(72) Inventors: Adam J. SIMON, Yardley, PA (US); Stephen J. MARTINO, Farmingdale, NJ (US)

(21) Appl. No.: 15/325,243

(22) PCT Filed: Jul. 10, 2015
(86) PCT No.: PCT/US15/39961

§ 371 Date: Jan. 10, 2017

Related U.S. Application Data
(60) Provisional application No. 62/023,729, filed on Jul. 11, 2014.

(51) Int. Cl. G06F 19/00

(52) U.S. Cl. CPC G06F 19/322; G06F 19/3481; G06F 19/324; G06F 19/363

(57) ABSTRACT

A system is provided for collecting medical data about a subject between visits to a health care professional. The system includes a medical records database that stores patient data for access by the health care professional and an interactive and distributed data collection system provided to a team of collaborators (doctors, parents, teachers, etc.) who are to collect data about the subject between visits to a health professional. The data collection system includes a plurality of mobile computing devices implementing a software application adapted to periodically collect symptoms data and activity data about the subject in response to prompts relating to the subject's condition, to enable chat discussions amongst the team of collaborators about the symptons and activities of the subject, and to periodcally forward the collected data in a report to the medical records database.

### CROSS REFERENCE TO RELATED APPLICATIONS

This application claims priority benefit of U.S. Provisional Patent Application No. 62/023,729 filed Jul. 11, 2014. The content of that patent application is hereby incorporated by reference in its entirety.

### TECHNICAL FIELD

The invention relates to the distributed collection, diagnosis, and analysis of brain health information.

### BACKGROUND

Normal functioning of the brain and central nervous system is critical to a healthy, enjoyable and productive life. Disorders of the brain and central nervous system are among the most dreaded of diseases. Many neurological disorders such as stroke, Alzheimer's disease, and Parkinson's disease are insidious and progressive, becoming more common with increasing age. Others such as schizophrenia, depression, multiple sclerosis and epilepsy arise at younger age and can persist and progress throughout an individual's lifetime. Sudden catastrophic damage to the nervous system, such as brain trauma, infections and intoxications can also affect any individual of any age at any time.

Most nervous system dysfunction arises from complex interactions between an individual's genotype, environment and personal habits and thus often presents in highly personalized ways. However, despite the emerging importance of preventative health care, convenient means for objectively assessing the health of one's own nervous system have not been widely available. Therefore, new ways to monitor the health status of the brain and nervous system are needed for normal health surveillance, early diagnosis of dysfunction, tracking of disease progression and the discovery and optimization of treatments and new therapies.

Unlike cardiovascular and metabolic disorders, where personalized health monitoring biomarkers such as blood pressure, cholesterol, and blood glucose have long become household terms, no such convenient biomarkers of brain and nervous system health exist. Quantitative neurophysiological assessment approaches such as positron emission tomography (PET), functional magnetic resonance imaging (fMRI) and neuropsychiatric or cognition testing involve significant operator expertise, inpatient or clinic-based testing and significant time and expense. One potential technique that may be adapted to serve a broader role as a facile biomarker of nervous system function is a multimodal assessment of the brain from a number of different forms of data, including electroencephalography (EEG), which measures the brain's ability to generate and transmit electrical signals. However, formal lab-based EEG approaches typically require significant operator training, cumbersome equipment, and are used primarily to test for epilepsy and detect seizures. Another major issue hampering proper understanding is the inability to collect the proper information necessary to decide best approaches to manage cases of brain injury and disease.

Alternate and innovative data collection approaches are needed to provide quantitative measurements of personal brain health that could greatly improve the prevention, diagnosis and treatment of neurological and psychiatric disorders. Unique distributed data collection approaches and devices that lead to biomarkers of Parkinson's disease, Alzheimer's disease, concussion, Autism and other neurological and neuropsychiatric conditions is a pressing need.

### SUMMARY

A system is provided for collecting medical data about a subject between formal clinical visits to or with a health care professional. The system includes a medical records database that stores patient data for access by the health care professional and an interactive and distributed data collection system provided to a team of collaborators (doctors, parents/adult children, teachers, etc.) who are to collect data about the subject between visits to a health care professional. The data collection system includes a plurality of mobile computing devices implementing a software application adapted to periodically collect symptoms data, neuropsychological performance data, and activity data about the subject in response to prompts related to the subject's condition, to enable chat discussions amongst the team of collaborators about the symptoms and activities of the subject, and to periodically forward the collected data in a report to the medical records database. The collaborators may be prompted to provide input about the subject by the software application or by email alerts and/or text-based SMS/MMS prompts from the medical records database. Each report includes a collection of the symptoms and activity data and/or chat input provided by the collaborator using the respective mobile computing device. Also, in an alternative embodiment, the software application may be adapted to further collect data from biosensors that extract data from the subject.

### BRIEF DESCRIPTION OF THE DRAWINGS

Embodiments of the invention can be better understood with reference to the following drawings, of which:

FIG. 1 is a schematic diagram illustrating the information technology architecture of an exemplary embodiment of the invention.

FIG. 2 is a schematic diagram illustrating the logic flow of a software mobile application in the distributed data collection mode for collecting patient data in an exemplary embodiment, with some relation to concussion.

FIGS. 3A-3M illustrate a series of screen shots of the software mobile application of FIG. 2.

FIG. 4A is a graphical display scatter plot between the vertical time (VT) and horizontal time (HT) within a subject of a proprietary saccade task, showing no systematic difference between horizontal and vertical time.

FIG. 4B is a graphical display scatter plot between the first block of three cards and the second block of three cards in the published 2×3 saccade test [King-Devick].

FIG. 5A is a graphical display scatter plot between a literature supported saccade task (the 2×3 Saccade task) on the y-axis versus the Set Shifted improvement of the Developmental Eye Movement (DEM) task Horizontal Time (HT, seconds) on the x-axis.

FIG. 5B is a graphical display scatter plot between a literature supported saccade task (the 2×3 Saccade task) on the y-axis versus the Set Shifted improvement of the Developmental Eye Movement (DEM) task Vertical Time (VT, seconds) on the x-axis.

FIG. 5C is a graphical display scatter plot between a literature supported saccade task (the 2×3 Saccade task) on the y-axis versus the Set Shifted improvement on the Developmental Eye Movement (DEM) task and its HT/VT ratio on the x-axis.

FIG. 6A illustrates a table included in the daily data collection report for a health professional's review enabled by the present invention.

FIG. 6B illustrates a table of a subject circle HIPAA compliant chat report for a health professional's review enabled by the present invention.

FIG. 7 is a schematic diagram illustrating the logic flow of a software mobile application in the distributed data collection mode for collecting patient data in an exemplary embodiment, with some relation to headache.

FIGS. 8A-8P illustrate a series of wireframes and navigation of the software mobile application of FIG. 7.

FIG. 9 is a schematic diagram illustrating the logic flow of a software mobile application in the distributed data collection mode for collecting patient data in an exemplary embodiment, with some relation to insurance claims processing.

FIGS. 10A-10S illustrate a series of wireframes and navigation of the software mobile application of FIG. 9.

FIG. 11A-11H is a series of template input forms which can be programmed by a customer to create a customized battery of questions and forms for the patient to respond to on a daily basis.

### DETAILED DESCRIPTION OF ILLUSTRATIVE EMBODIMENTS

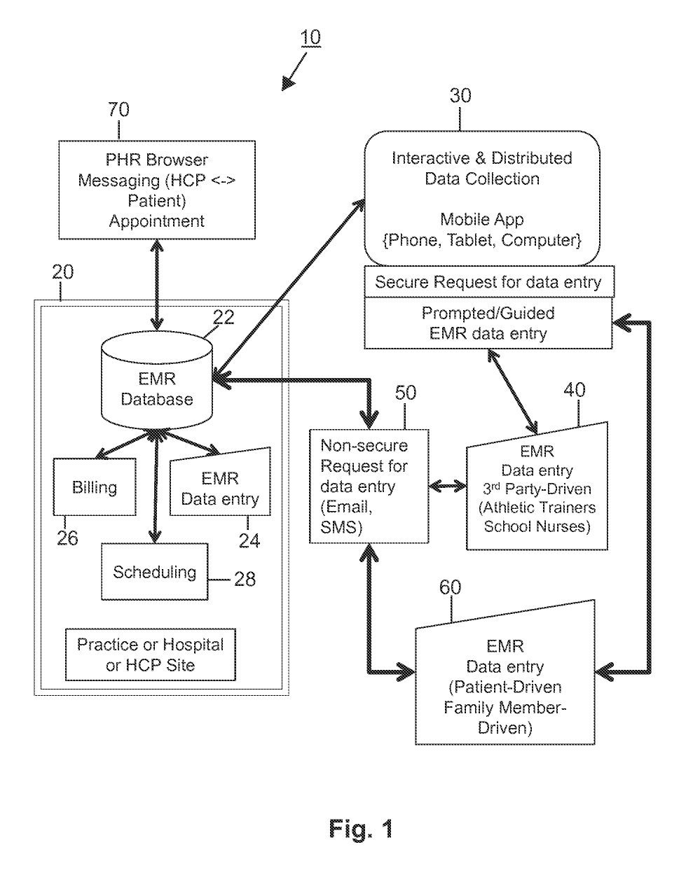

The invention will be described in detail below with reference to FIGS. 1-11. Those skilled in the art will appreciate that the description given herein with respect to those figures is for exemplary purposes only and is not intended in any way to limit the scope of the invention. All questions regarding the scope of the invention may be resolved by referring to the appended claims.

### A System of Multiple Data Entry Points to Collect Brain Health Data

The systems and methods of the invention comprise multiple data entry points into a remote cloud based database and software as a service application. Primary data collection of various modes of data is through traditional PC and tablet devices such as desktop, laptop and tablet computers. Through such devices, web based portals are an attractive means of data entry. For instance, a human subject can place himself in front of a computer, tablet, smartphone or other web browser enabled computing device (e.g. Chromebook) and interact by answering subjective psychological questions about how he is feeling at that time. The responses can be captured by the PC and securely transferred to a remote database server whereby the data is stored in a database. As a non-limiting example, this database can consist of multiple data tables as found in a Relational Database Management System or JavaScript Document Notation as found in a NoSQL document database, or a graph-based database.

FIG. 1 is a schematic diagram illustrating the information technology architecture of a system in accordance with the invention. As shown, the system 10 includes a web portal and interface as well as a mobile app based data collection and communication tool. To the left is a traditional electronic medical record (EMR) system 20 including an EMR database 22, EMR data entry system 24, billing system 26, and scheduling system 28. The EMR system 20 may, for example, be located at a practice site, hospital site, or healthcare professional site. On the right is the interactive and distributed data collection system of the invention, which adds the ability to collect and report medical data between visits to health care professionals (such as doctors and clinical psychologists, chiropractors, etc.), affiliated health care professionals (such as certified athletic trainers, nurses, physical therapist, etc.), organizations (such as school systems, employers, family), and other social networks with a permissions based system to respect the privacy and security of an individual's health and wellness information. The interactive and distributed data collection system of the invention includes interactive and distributed data collection software 30 running on smartphones, tablets, television operating systems, video telecommunications and other in-home interactive communication devices. The system 10 is augmented by the addition of bi-directional communication from the remotely distributed data collection apps 30 running on mobile devices such as smartphones and tablets.

The app software 30 enables an adult patient or subject in one embodiment, or alternatively minor subjects, to input data regarding their daily status in a HIPAA compliant fashion. The system 10 both receives data from multiple sources of input into the portion of the database 22 associated with a given subject, but it also permits communication and collaboration among extended teams and circles around the subject. In one embodiment, the parents of a minor subject give permission to the school nurse, the school math teacher, school English teacher, and school gym teacher to provide inputs via apps 40 running on their computers or mobile devices such a smartphones and tablets, optionally in response to electronic communications at 50. Similarly, inputs from the patient or other family members may be provided via apps 60 running on other computers or mobile devices. Thus, the circle around the subject includes the doctor (the Medical team), the parents (the Home team), the school nurse (part of the school team), the math and English teachers (the School academic team) and the school gym teacher (the School Athletic team). This integration of the various teams around the subject enables an enhanced communication to take place and permits the physician and medical team to review the daily correspondence to get an enhanced clinical impression at follow-up visits that would not otherwise be possible without the present invention.

In another non-limiting embodiment, the app software 30 enables a senior citizen patient or subject to give permission to their healthcare professionals, adult children, adult grandchildren, adult members of the nursing home community, nursing home staff, or other adult friend, the ability to join the system to input data regarding their daily status in a HIPAA compliant fashion. The system both receives data from multiple sources of input into the database associated with a given subject, but it also permits communication and collaboration among extended teams and circles around the subject. Thus, the circle around the subject includes the doctor and other healthcare professionals (the Medical team), the adult children, the nursing home staff, the adult friends of the subject with deep long relationships. This integration of the various team's around the subject enables an enhanced communication to take place and permits the physician and medical team to review the daily correspondence to get an enhanced clinical impression at follow-up visits that would not otherwise be possible without the present invention.

In another non-limiting embodiment, the app software 30 enables an insurance company the possibility to empower a patient, claimant, subject, or participant (collectively “participant”) to give permission to their healthcare professionals, spouse, adult children, parents, adult grandchildren, affiliated health care professionals (such as physical therapist, occupational therapist, speech therapist, cognitive therapist), and possibly adult co-workers, the ability to join the system to input data regarding the daily status of the participant in a HIPAA compliant fashion. The system both receives data from multiple sources of input into the database associated with a given participant, but it also permits communication and collaboration among extended teams and circles around the participant. Thus, the circle around the participant could include the doctor and other healthcare professionals (the Medical team), the spouse, adult children, or adult relatives (Family team), and adult co-workers including possibly a management supervisor (the Work team). This integration of the various team's around the participant enables an enhanced communication to take place and enables the physician and risk management team to review the daily correspondence to get an enhanced clinical impression at follow-up visits that would not otherwise be possible without the present invention.

In addition to receiving data from the Patient driven, family driven, or 3^{rd} party driven data entry, the system has the capability to deliver secure messages via messaging component 70 out to the circle of people around the subject or participant. By means of messaging component 70, the system 10 is able to prompt the parents via text (SMS, MMS), voice, email, Skype or other electronic communication channels to respond with daily data input around the subject or participant. If the subject or participant is an adult, the prompt would go directly to the subject but could also be configured to go to others including adult children in the case of a senior citizen.

Design of a Software App to Both Collect Daily Data and Enhance Daily Communication with Built in Prompts and Alerts Related to Concussion

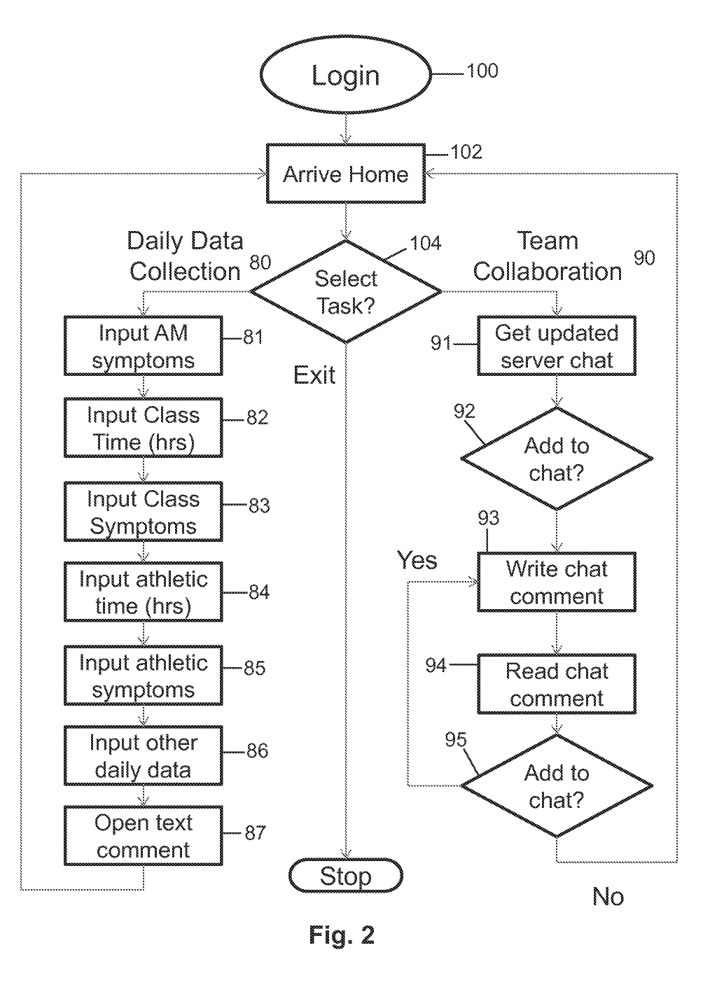

FIG. 2 is a schematic diagram illustrating the flow of a software mobile app 30 in the distributed data collection mode including both a “Daily Data Collection” communication module 80 as well as a “Team Collaboration” communication module 90. In accordance with the flow of the software illustrated in FIG. 2, the user logs into the app 30 at 100 and then lands on a home page at 102. From there, the user has the choice at 104 of recording daily data collection using module 80 by going through a series of symptom and data input screens 81-87 which capture psychological and neuropsychological data in one embodiment but can also be envisioned to include biosensor based measurements in alternate embodiments. Once the daily data collection has taken place, the user is able to either exit the system at step 104 or to engage in Team Collaboration around the subject using module 90 and to use module 90 to read and contribute to chat around a subject via collaboration steps 91-95. Once securely logged into the system, the user can review the recently posted chat entries about that subject and then use module 90 to contribute logged comments that will be visible to others invited into the circle around the subject.

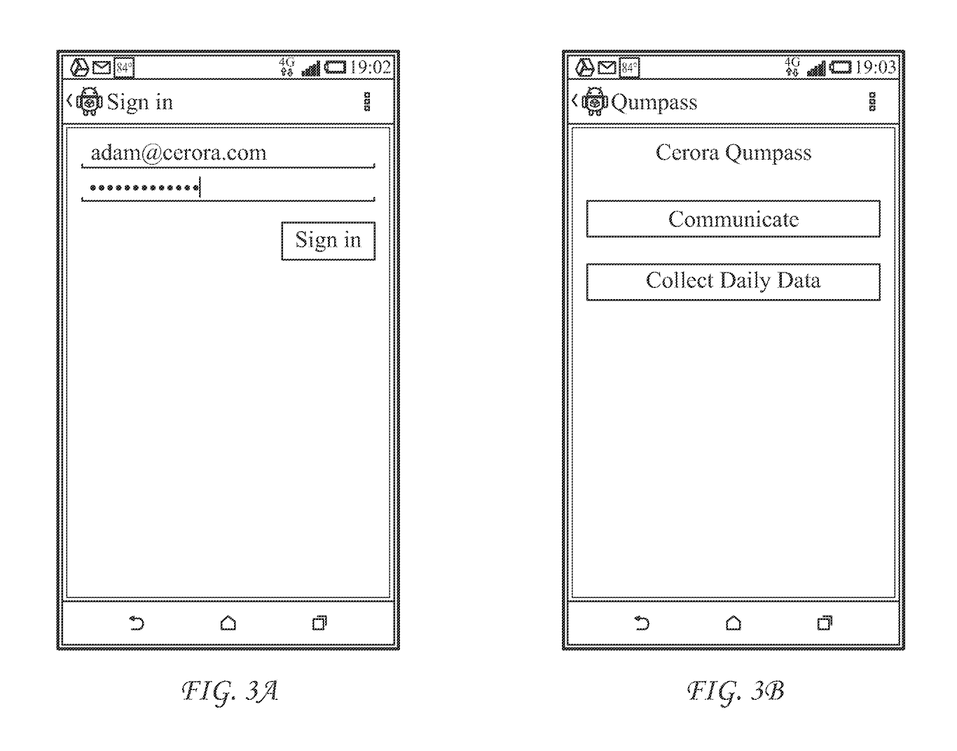

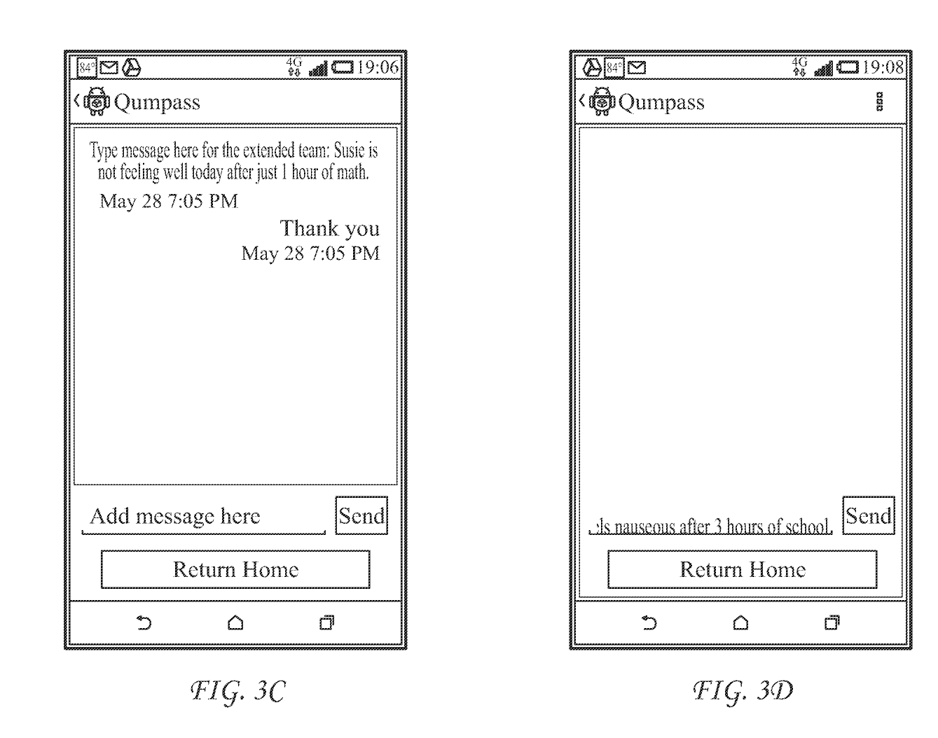

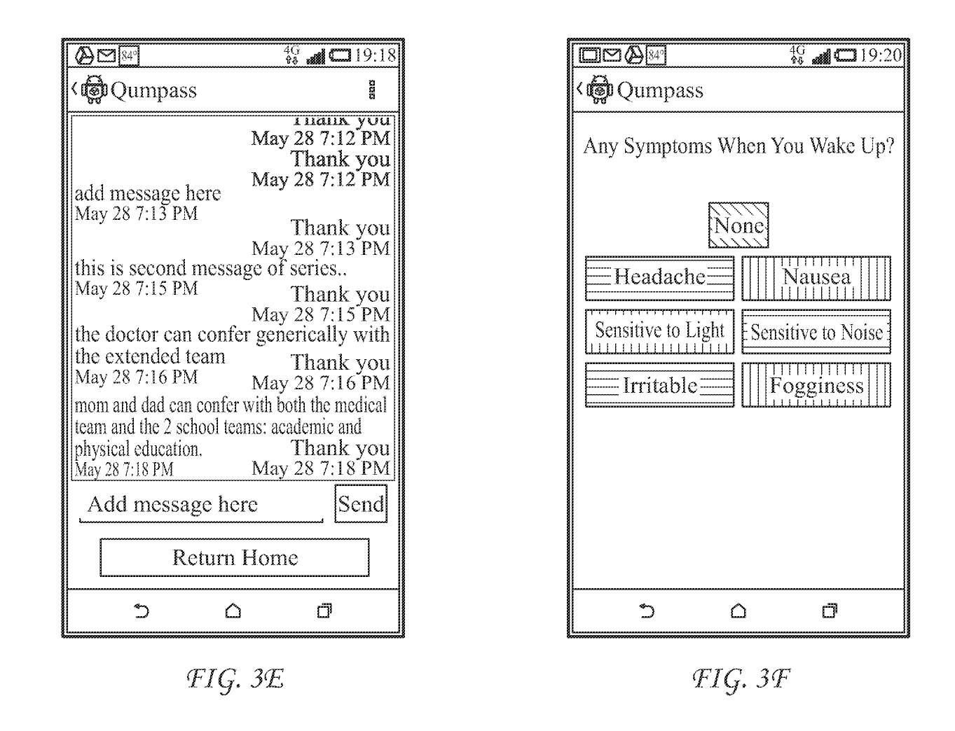

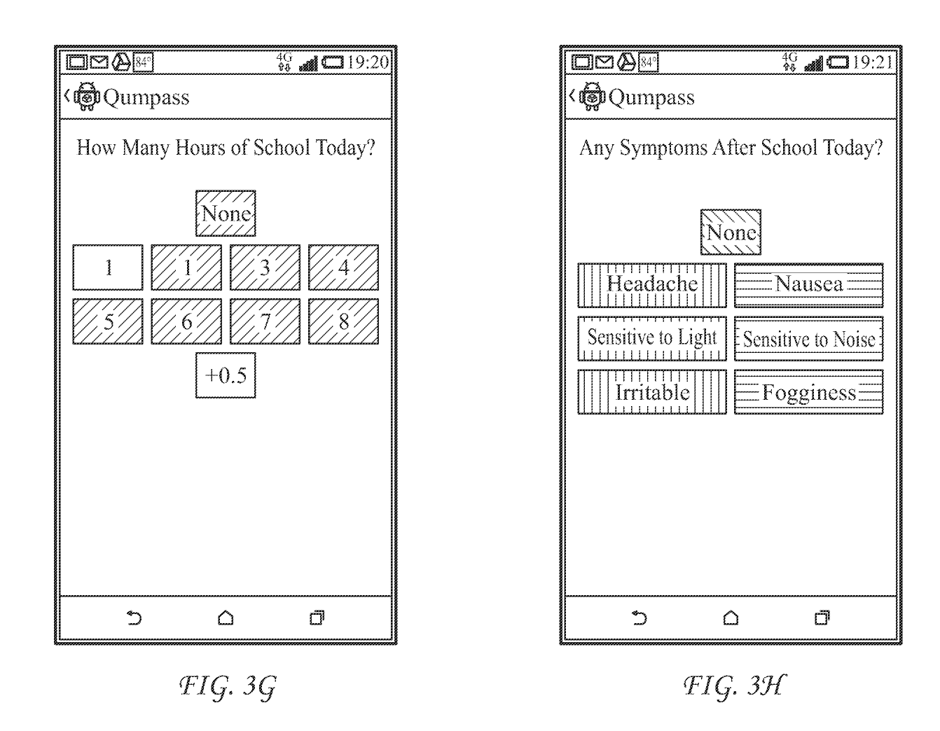

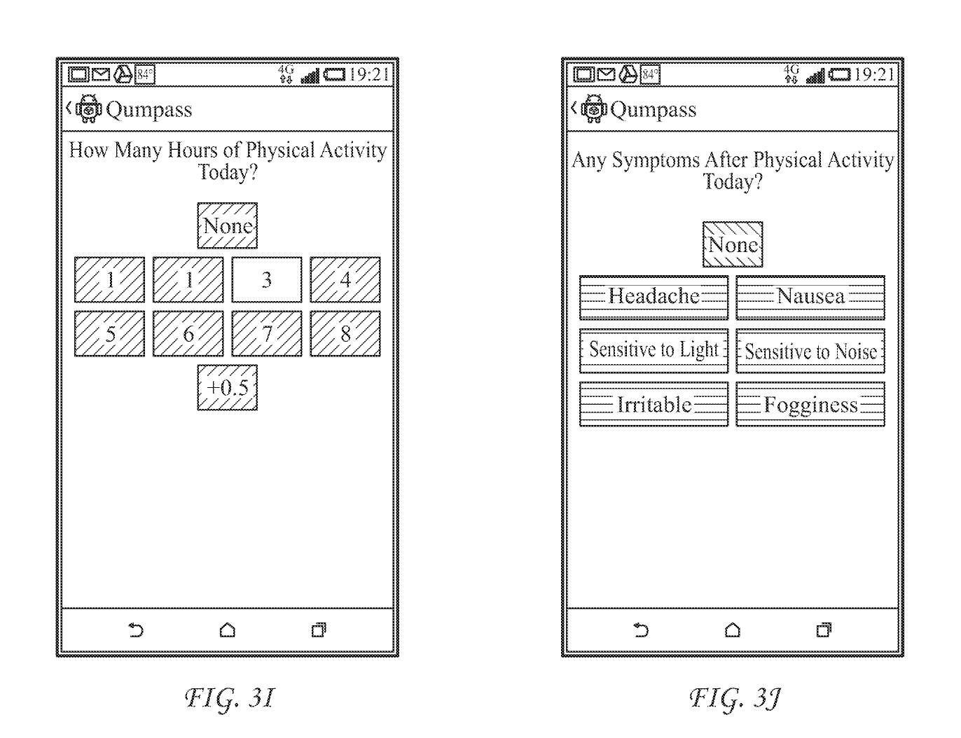

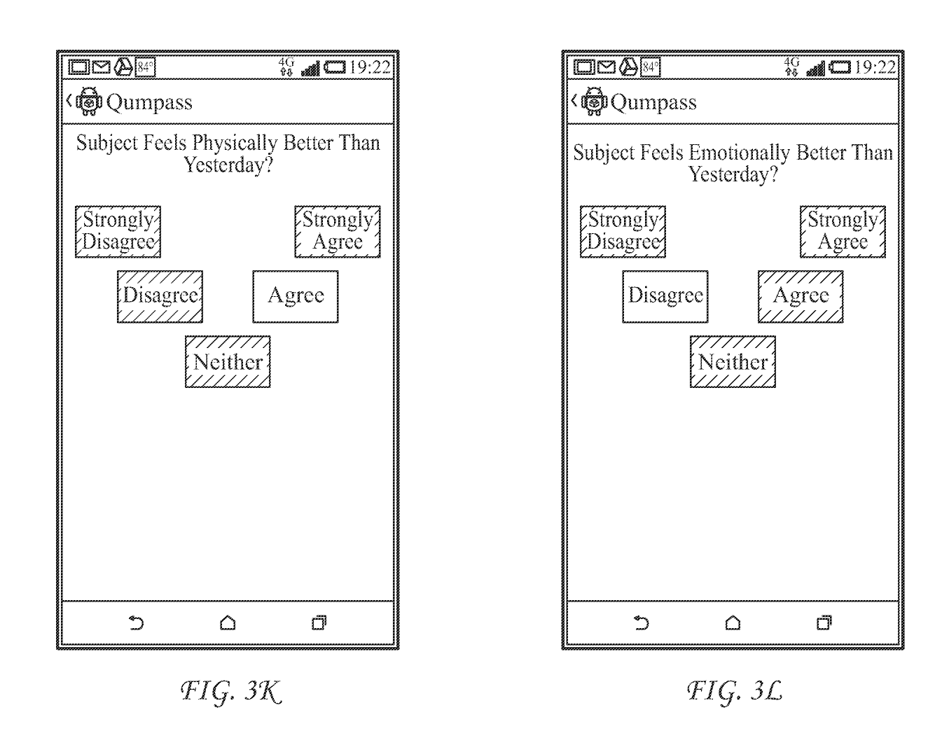

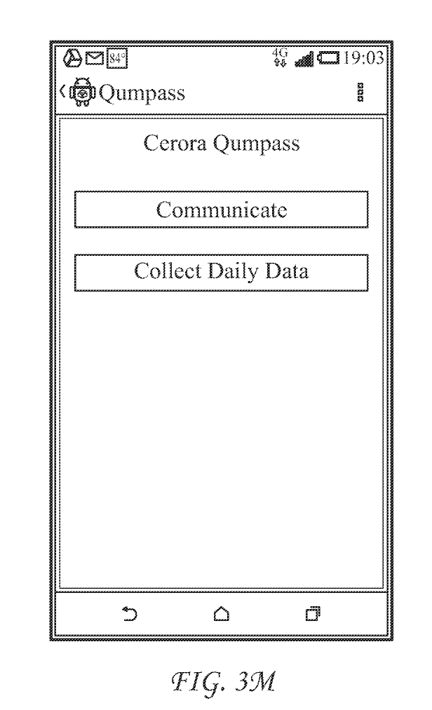

Screen shots of an example software app 30 implementing the flow of FIG. 2 and running on an Android device can be seen in FIGS. 3A-3M as a non-limiting exemplification of the flow chart shown in FIG. 2. FIG. 3A is a login screen. FIG. 3B is the home page. FIG. 3C is the Collaboration/communication tool first screen showing existing chat within the circle around a given subject. FIG. 3D illustrates a chat being entered in the text box at the bottom. FIG. 3E is an example of extended chat. FIG. 3F is an example of early AM symptom report form; FIG. 3G is a daily number of hours of class time report form; and FIG. 3H is a post class symptom report form. FIG. 3I is a daily number of hours of athletic activity time report form. FIG. 3J is a post athletics symptom report form. FIG. 3K is a relative comparison report form, and FIG. 3L is another relative comparison report form. FIG. 3M is a final return home screen shot. Importantly, critical data around time in class and sports (e.g., FIG. 3G and FIG. 3I) will be collected on a daily basis, enabling health care professionals to better manage patients, particularly patients with concussion symptoms. Symptom information (FIGS. 3F, 3H, and 3J) is also collected.

Although not shown, neuropsychological task based data may also be collected. In another embodiment, biosensor based data collection is possible using brainwave sensors, heart rate sensors, balance sensors, and voice sensors, with all data being fed synchronously into the electronic medical record database 22.

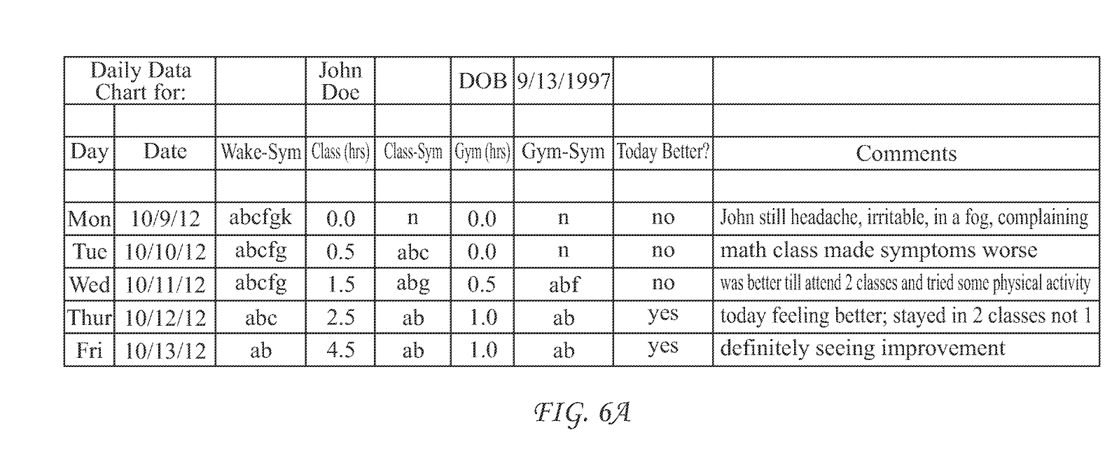

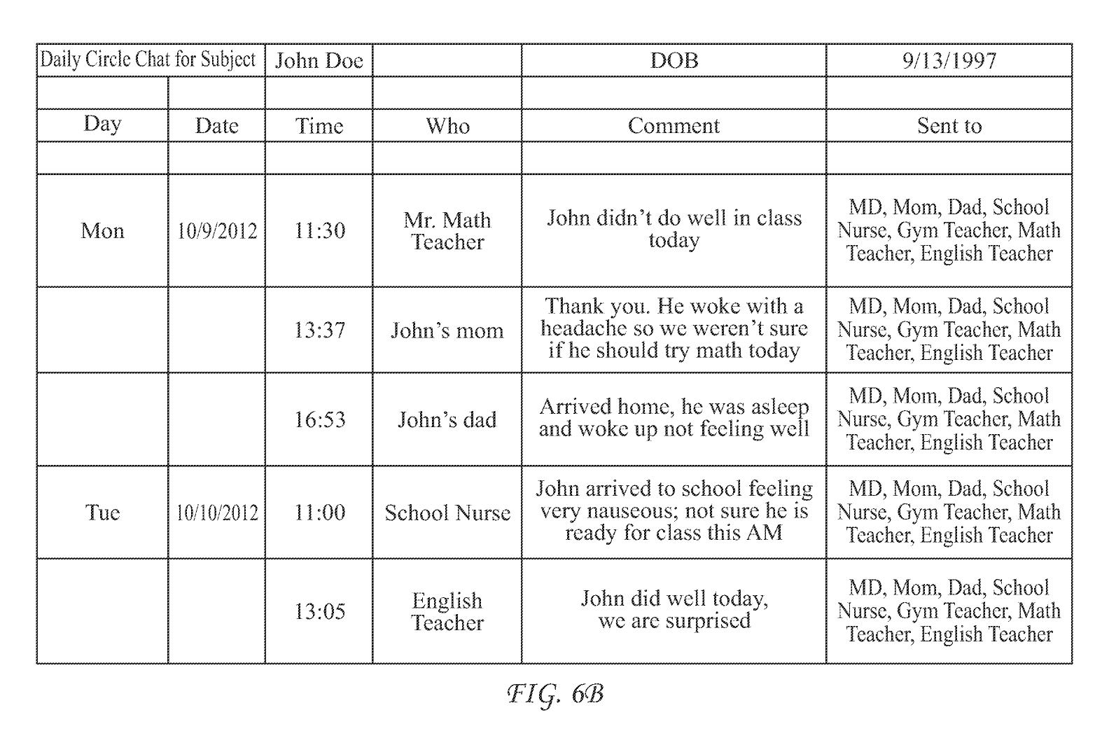

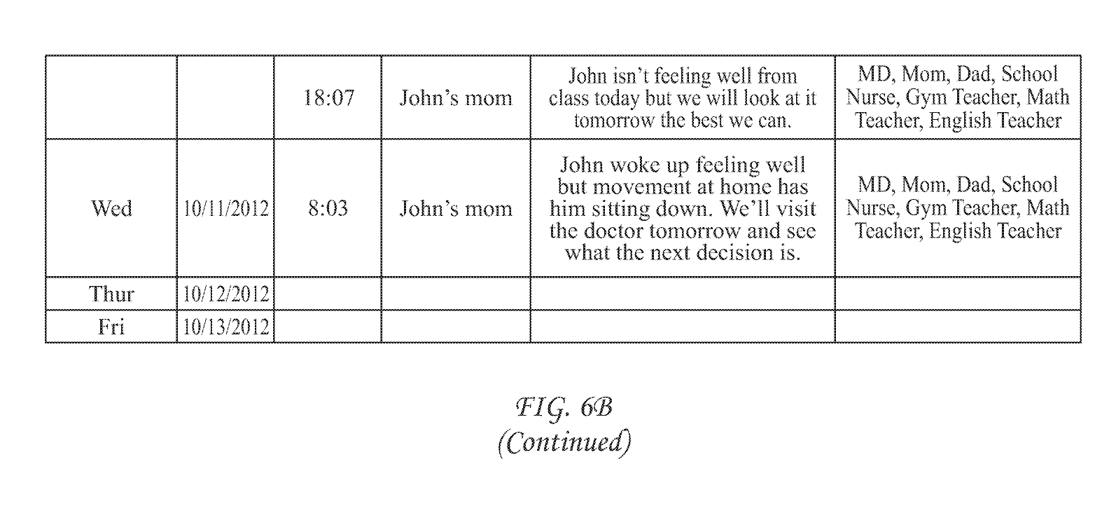

The collected data is summarized in a report, as exemplified in FIG. 6A, to enable a health care professional such as a doctor to review what has been going on with a subject in between office visits. Furthermore, the private chat within the circle may be summarized in a Chat report, as exemplified in FIG. 6B, which further assists a health care professional to get a more informed clinical impression of the patient and thus make a more powerful clinical plan for that subject.

Design of a Software App to Both Collect Daily Data and Enhance Daily Communication with Built in Prompts and Alerts Related to Headache

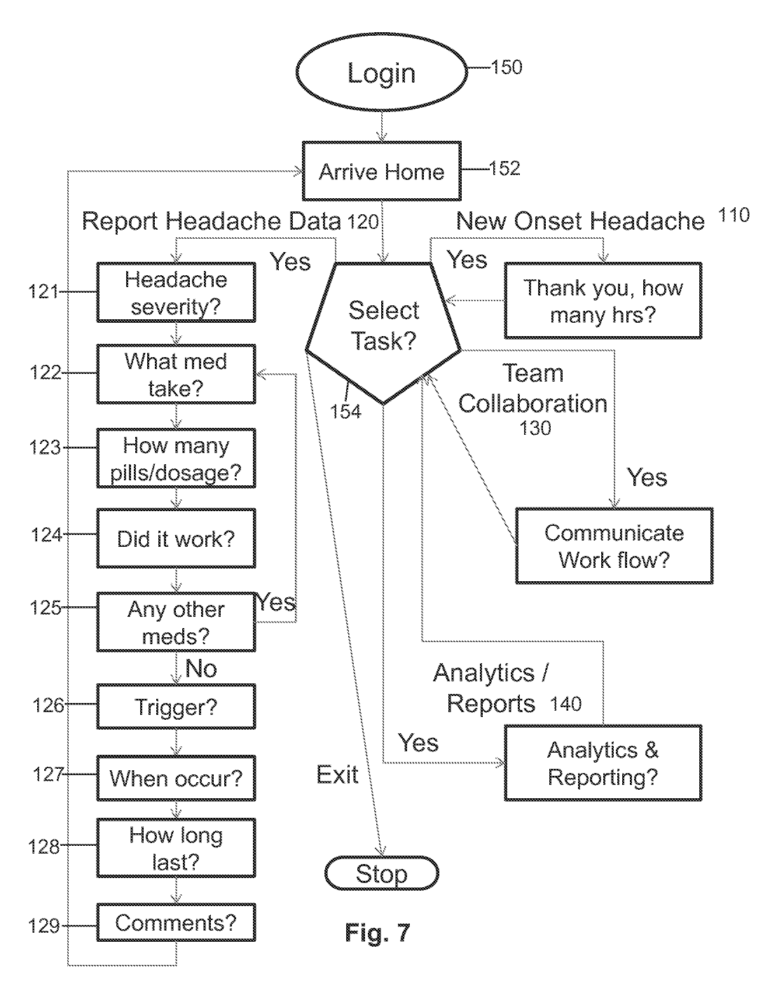

FIG. 7 is a schematic diagram illustrating the flow of a software mobile app 30 in the distributed data collection mode including both a “New Onset Headache” event collection module 110, a “Report Headache Data” data collection module 120, “Team Collaboration” communication module 130, and an “Analytics/Reports” graphical presentation and analysis module 140. In accordance with the flow of the software illustrated in FIG. 7, the user logs into the app 30 at 150 and then lands on a home page at 152. From there, the user has the choice at 154 of logging a new onset headache event using module 110, recording daily data collection via the “Report Headache Data” work flow using module 120 which includes going through a series of symptom and data input screens 121-129 which capture psychological and neuropsychological data in one embodiment but can also be envisioned to include biosensor based measurements in alternate embodiments. Once the daily data collection has taken place, the user is able to either exit the system at 154 or to engage in Team Collaboration and chat around the subject and to read and to contribute to chat around a subject in a HIPAA (both private and secure) fashion using module 130. There is the ability for the subject or participant to observe their longitudinal data graphically and to have prescribed analysis reported back to the subject using module 140. The analytics module 140 could alternatively suggest activities based on predictive models.

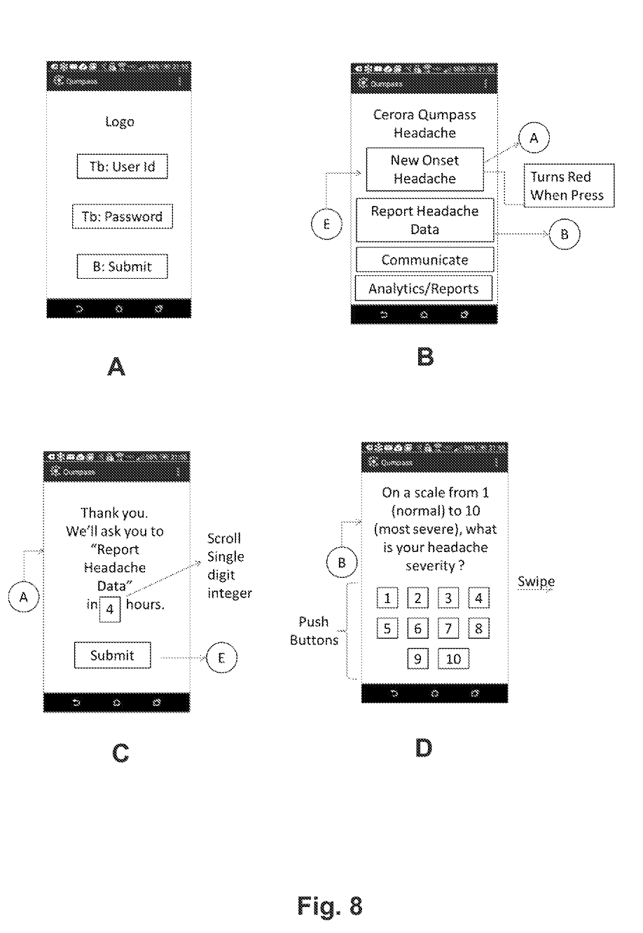

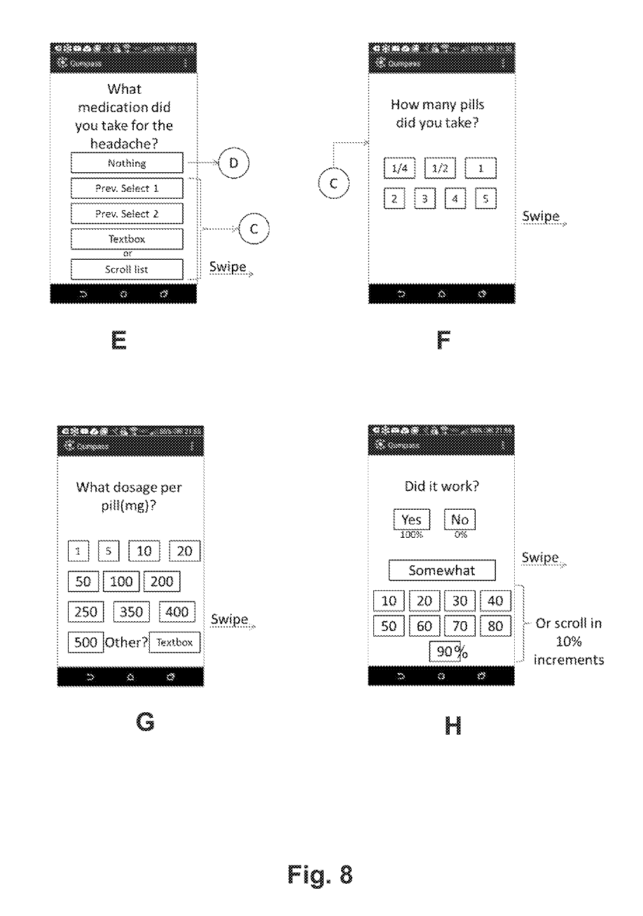

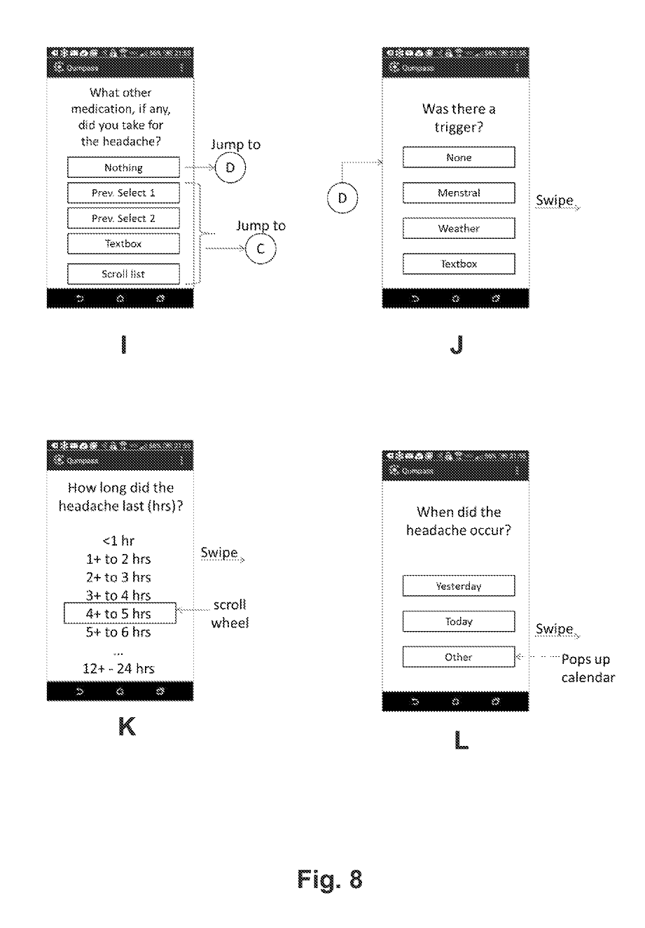

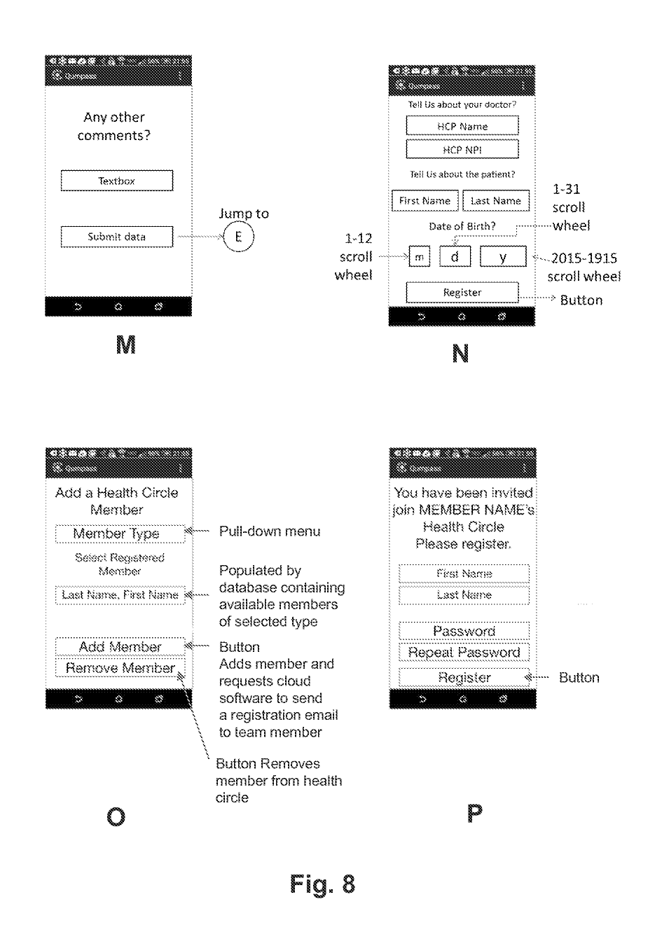

Wire frame illustrations or mock ups of an example software app 30 implementing the flow of FIG. 7 and running on an Android device can be seen in FIG. 8 as a non-limiting exemplification of the flow chart shown in FIG. 7. FIG. 8A is a login screen. FIG. 8B is the home page with a choice of four modules in this particular embodiment. FIG. 8C is the response to pressing the “New Onset Headache” button on the home screen which logs a new headache in the system and enables the user to define a response time when the system will prompt the user to input the headache data. Fixed variable choices will enable timely response to headache data.

FIG. 8D illustrates the first screen of the Report Headache data module as for an overall headache severity on a scale from 1 (mildest or non-existent) to 10 (most severe or horrible) from an array of push buttons or other graphical user interface input method. FIG. 8E is an example of a question around what medication was taken whereby “nothing”, a previous selection (e.g. from the day before or the previous onset headache) which is pre-populated to facilitate medication entry by the user but includes an open field text box or closed form scroll list to enable new medication entry. FIG. 8F is an example question around the number of pills taken (or liquid consumed or puffs inhaled depending on the dosage formulation.

FIG. 8G is a dosage per pill (or other suitable dosage depending on formulation) report form; FIG. 8H is a “Did it work” report form which can include intermediate responses via selection of the “Somewhat” button which enables selection of intermediate values between 0% (no it did not work) and 100% (yes it completely resolved the headache). FIG. 8I is an “Other medication” report form similar in structure to FIG. 8E. FIG. 8J is a “trigger” report form to enable contemporaneous collection of what may have caused the onset headache in order to help figure out what is the underlying cause. FIG. 8K is a duration of headache (in hours or other relevant scale) report form, and FIG. 8L is when did the headache occur report form to enable entry of data when a subject did not log the event while it was taking place. FIG. 8M is an open text box report form to enable entry any other comments by the subject. FIG. 8N is an example of a setup screen whereby after installation, the subject would enter the healthcare professional's organization name, the health care professional's name (e.g. Dr. John Hancock), the National Provider Index for that healthcare provider in order to register their app with the cloud based server and permit access to the appropriate restricted portion of the database. FIG. 8O is an example of a setup screen whereby after installation and registration a subject could invite members of the Medical team, the Home team, the School academic team, or the School Athletic team to share information collected by the app in a HIPAA-compliant manner. The subject may only see and select from a list of previously registered users in the EMR or invite users that are not currently in the EMR database. FIG. 8P is an example registration form for an invited circle participant such as a family member or co-worker.

Design of a Software App to Both Collect Daily Data and Enhance Daily Communication with Built in Prompts and Alerts Related to Insurance Claims Processing

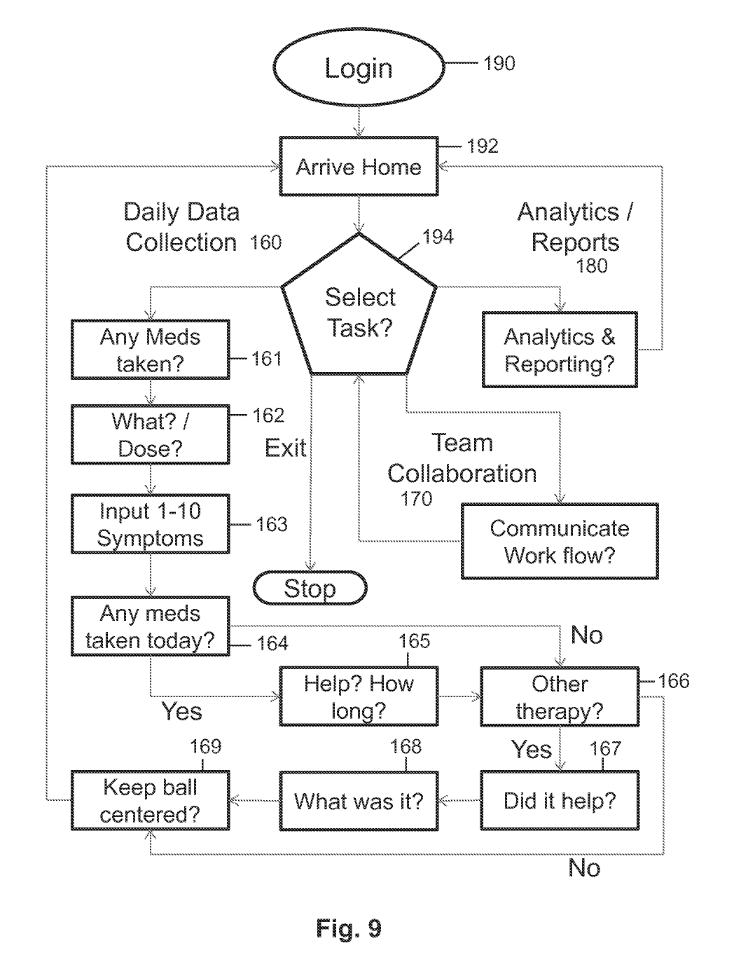

FIG. 9 is a schematic diagram illustrating the flow of a software mobile app 30 in the distributed data collection mode for use in insurance claims processing including both a “Daily Data Collection” communication module 160 as well as a “Team Collaboration” communication module 170. In addition, there is an analytics/reports option implemented by analytics/reports module 180 which would provide standardized analysis of the subject or participants data. In accordance with the flow of the software illustrated in FIG. 9, the user logs into the app 30 at 190 and then lands on a home page 192. From there, the user has the choice at 194 of selecting the condition from which they are dealing with the insurance company. This selection then proceeds to guide the subject to record daily data collection using module 160 going through a series of symptom and data input screens 161-169 which capture psychological and neuropsychological data in one embodiment but can also be envisioned to include biosensor based measurements in alternate embodiments. Once the daily data collection has taken place, the user is able to either exit the system at 194 or to engage in Team Collaboration around the subject using module 170 and to read and to contribute to chat around a subject. Once securely logged into the system, the user can review the recently posted chat items about that subject and then contribute logged comments that will be visible to others invited into the circle around the subject. Lastly, there is an option for the subject to see graphical presentation of the longitudinal data in the Analytics/Reports flow using module 180.

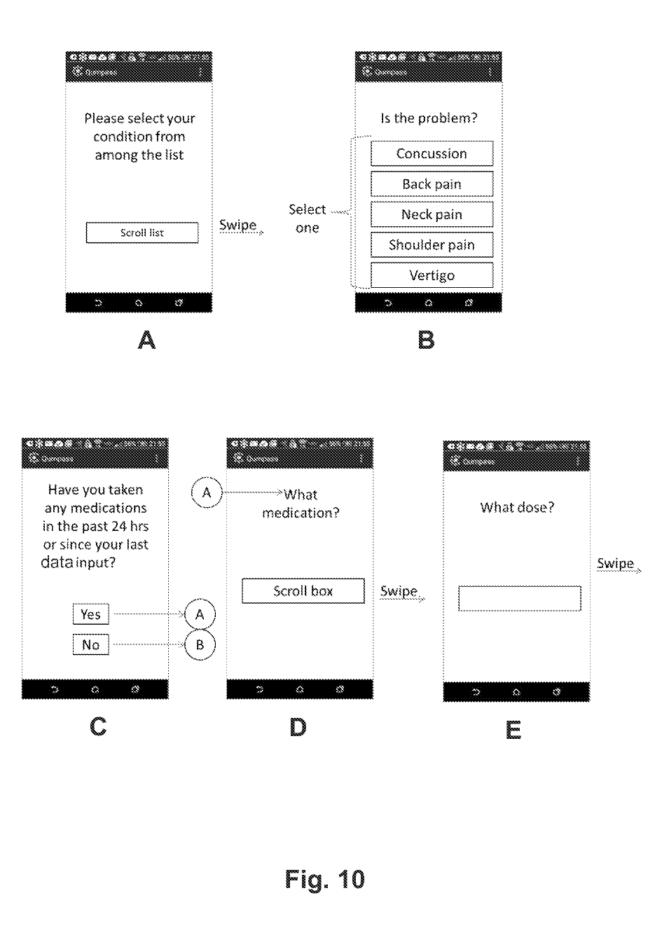

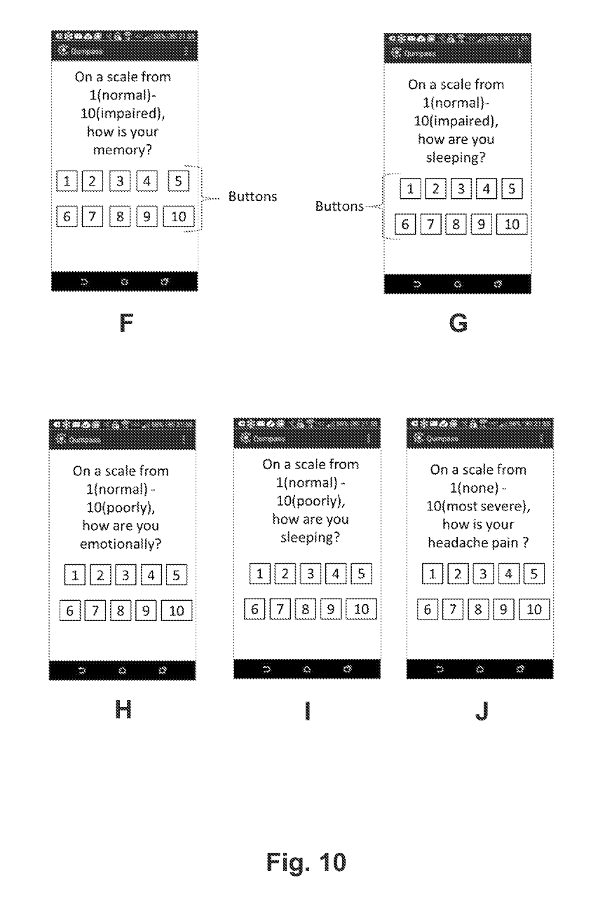

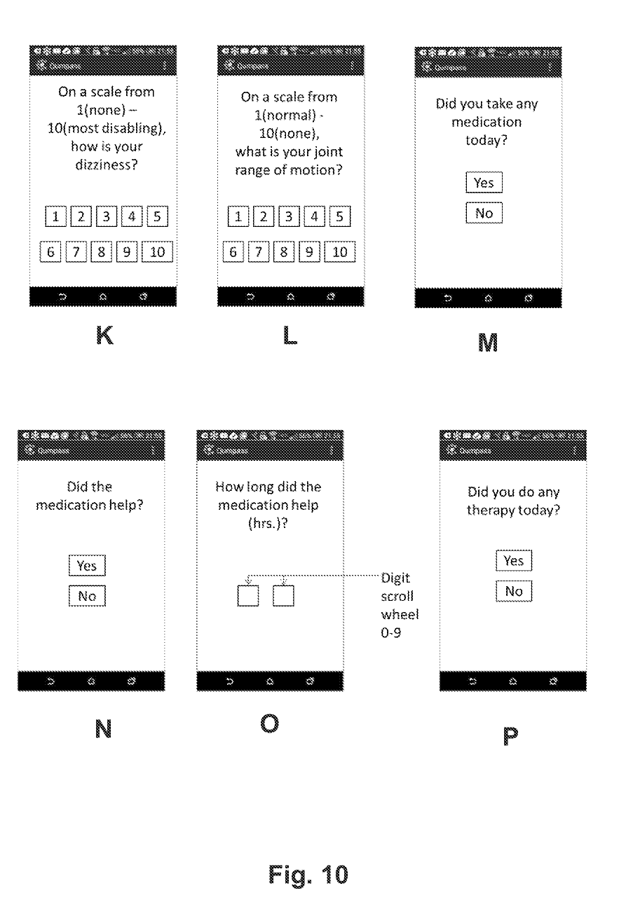

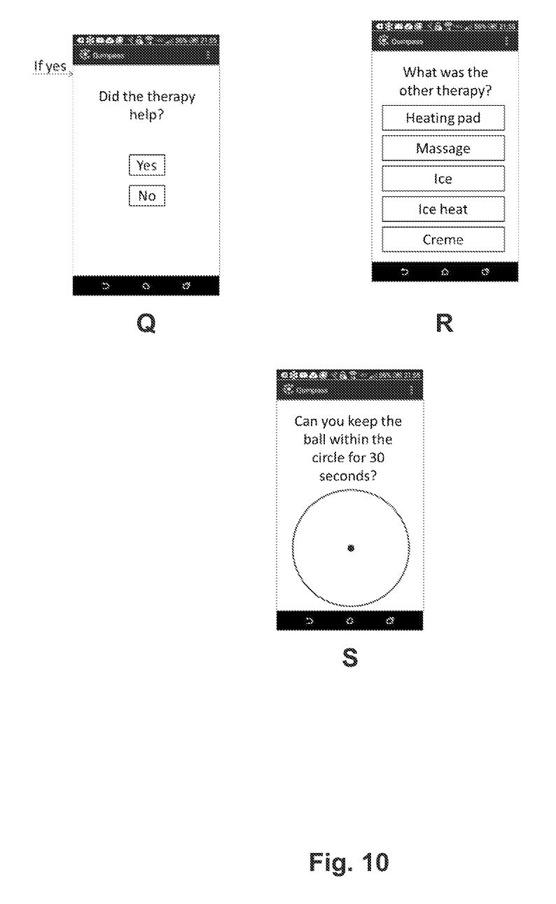

Wireframes of screens of an example software app 30 implementing the flow of FIG. 9 and running on an Android device can be seen in FIG. 10 as a non-limiting exemplification of the flow chart shown in FIG. 9. FIG. 10A is just after a login screen as already illustrated in FIG. 8A, which shows a condition selection scroll list or alternatively, in FIG. 10B a short list of common issues for consideration by the injured claimant.

FIG. 10C inquires about any medications taken in past 24 hours. FIG. 10D illustrates a medication input report form. FIG. 10E is a dose input report form; FIG. 10F through FIG. 10L are symptom questions based on a one to ten rating scale; and FIG. 10M is a follow-up medication question. FIG. 10N and FIG. 10O are medication refinement questions. FIG. 10P is an alternate therapy input report from. FIG. 10Q is a binary question report form related to the alternate therapy. FIG. 10R is a five choice item list report form around what the alternate therapy consisted of; while FIG. 10S represents a fine motor challenge to have the subject hold their smartphone device stable with a graphical image of a ball affected by gravity and wanting the ball to not touch the sides of a circle for a 30 second trial duration.

Though not shown, neuropsychological task based data may also be collected. In another embodiment, biosensor based data collection is possible using brainwave sensors, heart rate sensors, balance sensors, and voice sensors, with all data being fed synchronously into the electronic medical record database 22.

The collected data is summarized in a report, as exemplified as FIG. 6A, to enable a health care professional such as a doctor to review what has been going on with a subject in between office visits. Furthermore, the private chat within the circle may be summarized in a Chat report, as exemplified in FIG. 6B, which further assists a health care professional to get a more informed clinical impression of the patient and thus make a more powerful clinical plan for that subject.

Design of a Software App to Both Collect Daily Data and Enhance Daily Communication with Built in Prompts and Alerts Customized as a Precision Medicine Based Approach Using Template Input Forms

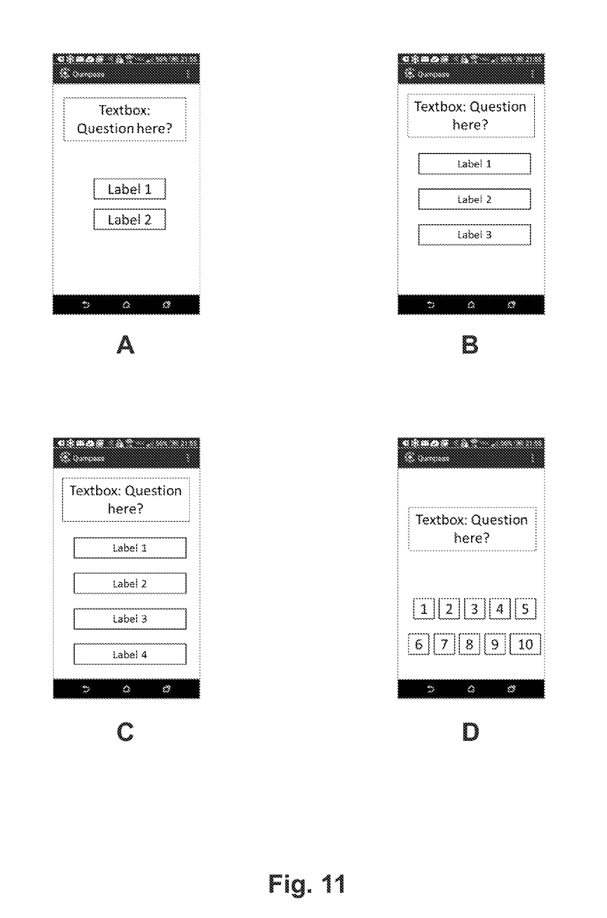

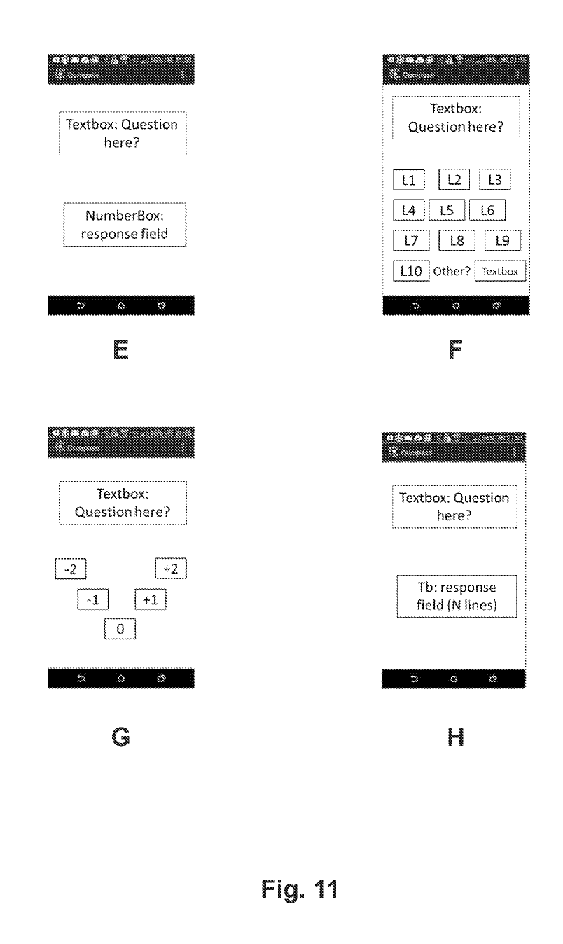

Wireframes of template based report forms are shown in FIG. 11. These template forms can be customized by a healthcare practitioner uniquely for as few as a single patient. This ability to customize take home data collection inventories would enable a physician or clinician to build an app with a series of forms which are strung together in a similar fashion to the way SurveyMonkey allows users to build custom surveys from template questions with varying levels of looping and conditional switching etc.

FIG. 11A is a binary choice question with a textbox entry for the text at the top to ask the question and choice of two buttons configured with “Label 1” and “Label 2” such as Yes/No, On/Off, Positive/Negative. FIG. 11B is a 3-way choice question with a textbox entry for the text at the top to ask the question and choice of three buttons configured with “Label 1”, “Label 2”, and “Label 3” such as negative/neutral/positive, check minus, check, check plus, etc. FIG. 11C is a 4-way choice question with a textbox entry for the text at the top to ask the question and choice of four buttons configured with “Label 1”, “Label 2”, “Label 3” and “Label 4”, typically in the form of short lists. FIG. 11D is a text based symptom form whereby a response is recorded on a scale of one through ten. FIG. 11E is a number response report form whereby an integer or floating point number (defined as M.N, where M=number of digits to the left of the decimal and N=number of digits after the decimal point). FIG. 11F is an item list plus other text box report form, while FIG. 11G is a 5 point Lichert scale question. Lastly, as a non-limiting example of generalized forms, FIG. 11H is an example open text box response whereby the number of lines of the textbox can be predetermined to help guide the subject/participant.

Though not shown, neuropsychological task based data may also be collected. In another embodiment, biosensor based data collection is possible using brainwave sensors, heart rate sensors, balance sensors, and voice sensors, with all data being fed synchronously into the electronic medical record database.

The collected data is summarized in a report, as exemplified in FIG. 6A, to enable a health care professional such as a doctor to review what has been going on with a subject in between office visits. Furthermore, the private chat within the circle may be summarized in a Chat report, as exemplified in FIG. 6B, which further assists a health care professional to get a more informed clinical impression of the patient and thus make a more powerful clinical plan for that subject.

### EXAMPLES

While the above description contains many specifics, these specifics should not be construed as limitations on the scope of the invention, but merely as exemplifications of the disclosed embodiments. Those skilled in the art will envision many other possible variations that are within the scope of the invention. The following examples will be helpful to enable one skilled in the art to make, use, and practice the invention.

### Example 1

### Pilot App Development and Usability Study

In an exemplary embodiment, the design of the software as illustrated in FIG. 2 was created as a web based SaaS offering. In addition, an Android operating system app was used to implement the process of FIG. 2 in order to collect the data required in ‘Return-to-Learn’ case study. The data collection mode was presented to N=8 human subjects to compare the results of a proprietary saccade test to a published 2×3 saccade card task.

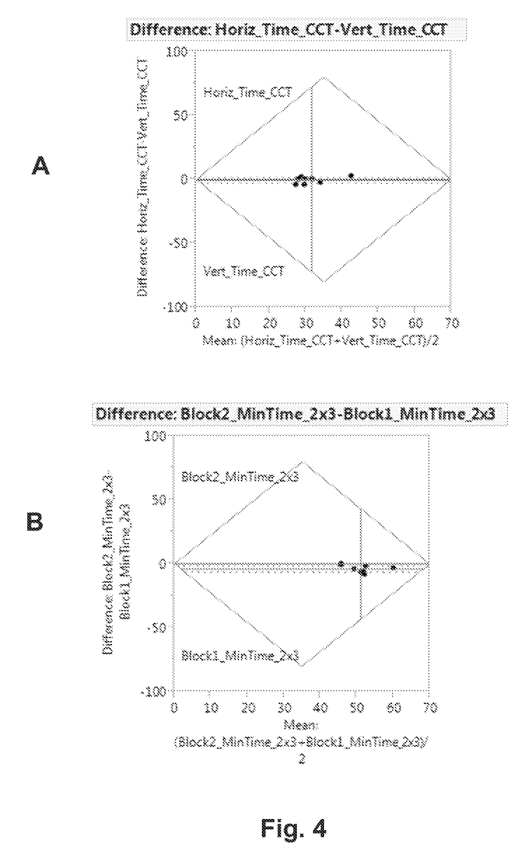

Subjects were asked to read off numbers from 3 saccade cards of increasing difficulty and then to repeat the three cards again. Once completed, the subject was asked to participate in the reading of 4 saccade cards; however, these cards were modelled on the Developmental Eye Movement cards where there are two vertical cards followed by two horizontal cards that are designed to de-convolve slow number reading from the inability to saccade properly. The results of the pilot study can be seen in FIG. 4, where in FIG. 4A the within subject vertical time (time to read the first two vertical cards summed together) is plotted against the same numbers and letters but in a horizontal orientation, the Horizontal Time, which is the sum of time to read cards 3 and 4. One sees in FIG. 4A that there is no difference between the vertical time VT and horizontal time HT in the N=8 subjects. In the alternative, when one looks at the within subject time to read the first block of 3 cards in the 2×3 saccade task, one sees a statistically meaningful difference in the second block from the first, evidence of a learning effect in the test schema, as shown in FIG. 4B by the statistically meaningful reduction in the Block 2 time relative to the Block 1 time to read the 3 horizontal saccade cards.

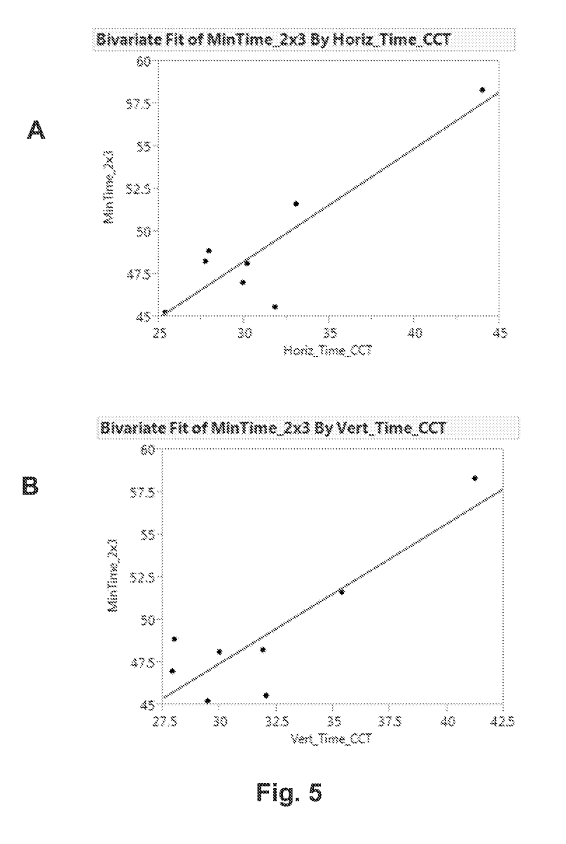

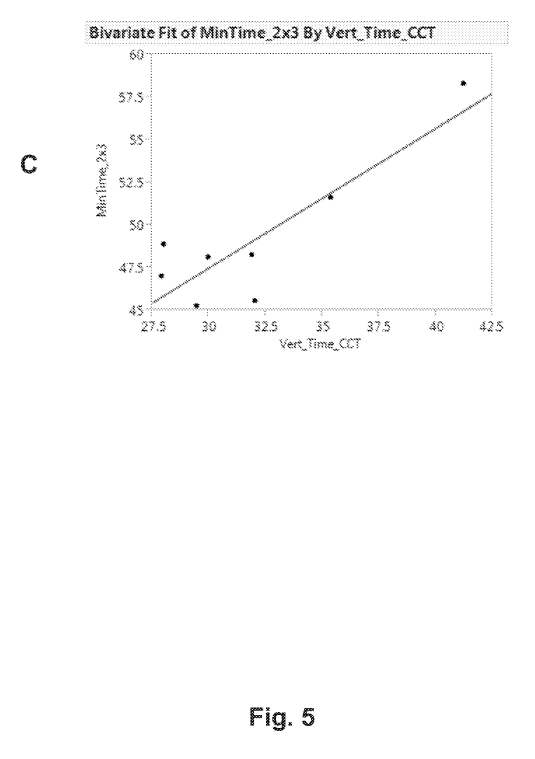

Upon further analysis between the two saccade tasks, one sees good agreement between the minimum block time in the 2×3 saccade task and the horizontal time HT as shown by the excellent correlation shown in FIG. 5A. In addition, the correlation between the minimum block time of the 2×3 saccade task is well correlated to the vertical time VT shown in FIG. 5B. Lastly, in FIG. 5C one can see that the ratio of the horizontal time HT to vertical time VT is close to one and correlated to the minimum block time for the 2×3 saccade task.

### Example 2

### Use in a Clinical Practice to Manage Concussion

In another exemplary embodiment, the invention can be used to enable better management of patients with traumatic brain injury or concussion. To date, there is no publication on how to manage a student back into the classroom to learn after a concussion. The system of the present invention enables parents of a minor subject or the subject themselves to enter daily data regarding how many hours of class activity and physical activity occurred on a daily basis. This data collection permits a clinician to review at the next clinical visit reports of the type shown in FIG. 6A about the daily data collection as well as the Health Circle Chat Report shown in FIG. 6B. By looking at longer term clinical outcomes, clinicians may better understand if it is better to hold students out of the classroom after concussion until they can sustain a full day of learning or if it is better to have a gradual return to the classroom even though the mental activity leads to exacerbated symptoms during the return to learn progression. With no published clinical evidence in the literature today, the system and data reports of the present invention permit answering this “Return-to-Learn” question through review of clinical histories.

Those skilled in the art will also appreciate that the invention may be applied to other applications and may be modified without departing from the scope of the invention. For example, the signal processing described herein may be performed on a server, in the cloud, in the electronics module, or on a local PC, tablet PC, smartphone, or custom hand held device. Also, all of the apps described or envisioned herein may be combined into one app as options of the app or provided as a series of apps configured to run on the same device. Accordingly, the scope of the invention is not intended to be limited to the exemplary embodiments described above, but only by the appended claims.

What is claimed:

1. A system for collecting medical data about a subject between visits to a health care professional, comprising:
a medical records database that stores patient data for access by the health care professional; and
a plurality of interactive and distributed data collection devices adapted for use by a team of collaborators who are to collect data about the subject between visits to a health professional, the interactive and distributed data collection devices comprising mobile computing devices implementing a software application adapted to periodically collect symptoms data and activity data about the subject in response to prompts relating to the subject's condition, to enable chat discussions amongst the team of collaborators about the symptoms and activities of the subject, and to periodically forward the collected data in a report to the medical records database.

2. The system of claim 1, wherein the software application prompts and measures compliance of each collaborator to input data about the subject's symptoms and/or activity or to provide a chat input about the subject.

3. The system of claim 1, wherein each report includes a collection of the symptoms and activity data and/or chat input provided by the collaborator using the respective mobile computing device.

4. The system of claim 1, wherein the software application is further adapted to collect data from biosensors that extract data from the subject.

5. The system of claim 1, wherein the medical records database is adapted to send email alerts and/or text-based SMS/MMS prompts to the collaborators to stimulate the entry of and measure compliance of symptoms and activity data and/or chat input from the respective collaborators.

6. The system of claim 1, wherein for a minor subject, the collaborators include the subject's health professional, the parents of the subject, and at least one of a school nurse, subject matter teachers, and a school gym teacher.

7. The system of claim 1, wherein the symptoms data and activity data relates to a concussion condition, a headache condition, or a brain condition asserted in a medical insurance claim.
